(19) United States
(12) Patent Application Publication
(10) Pub. No.: US 2018/0050715 A1
(43) Pub. Date: Feb. 22, 2018

(54) Lifting and Moving System for Gondolas and Storage Racks

(71) Applicant: Frank Charles COZZA, Santee, CA (US)

(72) Inventors: Frank Charles Cozza, Santee, CA (US); Gerry Taylor, Santee, CA (US)

(21) Appl. No.: 15/119,214

(22) PCT Filed: Aug. 10, 2016
(86) PCT No.: PCT/US2016/046423

§ 371 Date: Aug. 16, 2016

Related U.S. Application Data
(60) Provisional application No. 62/203,331, filed on Aug. 10, 2015.

(51) Int. Cl. B62B 5/00; A47B 91/00

(52) U.S. Cl. CPC B62B 5/0086; A47B 91/002

(57) ABSTRACT

A lifting and moving system for gondolas and storage racks and the like is provided allowing for elevation and relocation of such structures while fully loaded. The system employs a lifting member forming a cradled support of the horizontal supports of the gondola or pallet rack or the like, to during elevation by a jack engaged with a wheeled dolly.

This application claims priority to U.S. Provisional Patent Application Ser. No. 62/203,331 filed on Aug. 10, 2015, which is incorporated herein in its entirety by this reference thereto.

### BACKGROUND OF THE INVENTION

### 1. Field of the Invention

The present invention relates to storage racks and display racks for merchandise sold in stores, also well known as gondolas, pallet racks, and storage racks. More particularly, it relates to a system for engaging and elevating fully loaded gondolas, pallet racks, and display racks, to allow moving of such racks using wheeled dollies while fully loaded with merchandise.

### 2. Prior Art

Display structures which feature a plurality of horizontal shelves which are also known as gondolas are employed throughout the world for both the storage and the presentation of products to consumers visiting retailers. Such gondola structures and shelving units display the retail products which consumers buy, as well as food products and the like. It should be noted that gondola as used herein is for convenience of the description and is inclusive of any rack structure having shelves supported by vertical members extending from horizontal supports at the base. Such may include gondolas in stores, pallet racks, storage racks, display racks and other such display and storage components.

Such display structures which can be many feet long and have multiple elevated shelves are incredibly heavy when loaded with merchandise. Conventionally, such shelving is arranged in stores as well as warehouses, in lines of adjacent shelves which form an array of aisles therebetween. In commercial and retail settings, customers will walk along aisles formed in between the adjacently positioned shelves.

Due to the limited amount of floor space at such retail centers and stores, the display units often consist of multiples of shelves supported by a central structure. These shelves are positioned in a vertical array to increase the number of items of displayed merchandise per square foot of floor space. The shelves themselves are generally packed with merchandise to thereby serve as both a display and storage unit for the merchandise.

However, frequently, there arises a need to rearrange and move the heavily loaded gondola or display structures. Such a need arises where maintenance is required, or a store is remodeling, or a retailer wishes to move products held by the shelving to another location in the store.

Because the shelving functions as both a merchandise display, as well as a storage structure for large amounts of the displayed merchandise, it is very time consuming to load and unload the many shelves with the thousands of different products which may be on display at a given location. Unloading and then reloading stacked shelving is also extremely labor intensive and costly to employers. It is thus desirable to be able to move the entire gondola or display structures while fully loaded. This saves the time and cost of unloading the products from shelves, storing them elsewhere, and reloading the products once the display structure has been repositioned.

However, conventional gondola type display structures are many feet long, and six to eight feet tall or more. Because of the many tiered shelves, such gondolas, pallet racks and display structures tend to be top-heavy. As a consequence, the loaded shelves are easily toppled if they are elevated above the supporting floor surface for moving. They are thus very hard to move and maintain upright, without removing the products they contain.

There are a good number of gondola and pallet rack storage structure lifting and moving devices available. Such devices and systems generally include some form of a dolly on which an elevated display structure is placed, thereby allowing it to be rolled on dolly wheels to a new location. Conventionally, some type of jack may be employed to elevate the gondola or storage structure onto the elevated surface of a wheeled dolly.

Often, such conventional moving systems require multiple people to operate when positioning a gondola atop multiple dollies. They are also complex and difficult to operate. Many conventional display case lifting and moving devices are also limited in their use with heavily loaded display units, because the display unit may require tilting to be placed atop a dolly. As noted, because gondolas, pallet racks and product display structures have elevated shelving loaded with products, they tend to be easily toppled as they are top-heavy. Thus any tilting can be particularly hazardous due to the constant potential for the gondolas and pallet racks to fall over and thereby become damaged. Further there is a significant risk of injury to personnel as well as loss of value to the retailer for toppled products.

As such, there is a continuing unmet need for an improved device and system for secure lifting and relocation of such heavily loaded gondolas, pallet racks, and other elevated product display and storage structures. Such a system should include engageable components strong enough to handle the substantial weight load of a fully stocked gondola, pallet rack or display shelving unit. Further, such a system should be configured for easy engagement and subsequent easy removal. In addition, such a device and system should be able to mate with a variety of complimentary gondola and pallet rack geometries without modification. Further, because the jack and wheels for such systems generally are more expensive than the interface between the gondola or pallet rack or other shelving being lifted, such a system ideally should allow multiple gondolas or shelves to be engaged with the interface components and then remain so engaged. Such will thereby allow the operatively engaged wheeled lifting component to be engaged to the lifting member easily when needed and subsequently disengaged. Finally, such a device and system should also be configured to eliminate or significantly minimize tilting of the gondola, display rack or pallet rack when lifting, to minimize the risk of tipping and potential injury to operating personnel, as well as damage to displayed goods.

### SUMMARY OF THE INVENTION

The system and method herein disclosed and described achieves the above-mentioned goals through the provision of a lifting and relocating system for product shelving such as gondolas, pallet racks and display racks. The system employs lifting members to engage and lift gondolas and pallet racks to an elevated position above the support surface. It should be noted that the term gondola is used herein for convenience and is not intended to be limiting in any fashion. Gondola is intended to include gondolas for products and storage, pallet racks, storage racks for product sales and storage, and any rack with horizontally disposed shelves which are in elevated positions supported by vertical supports extending from underlying horizontal support members which may be engaged and lifted by the system herein.

The lifting members are each configured for easy secure engagement to, and disengagement from, wheeled lifting components such as dollies having screw jack or hydraulic jack or similar lifting component thereon. The lifting members are adapted for easy engagement and disengagement to opposing wheeled lifting components. The lifting members are also adapted for easy engagement to the support structure of product shelving such as gondolas, display racks, or pallet racks to which the lifting members are operatively engaged.

Each wheeled lifting component is securely engageable to one of the opposing ends of each lifting member in a manner allowing a screw-jack or other jacking or lifting means, positioned on each wheeled lifting component, to subsequently lift the engaged lifting members. The elevation of the lifting members which are operatively engaged to the support structure of the gondola, display rack or pallet rack, raise it to an elevated position above the underlying support surface. Once so elevated, the gondola, display rack or pallet rack is securely supported in the elevated position by the plurality of operatively engaged lifting members which are removably engaged to the wheeled lifting components.

Conventional gondolas and pallet racks and similar product display and storage structures, generally employ a plurality of horizontal supports to carry the load on the overhead vertically disposed shelves. The plurality of horizontal supports are positioned between both ends of the gondola or pallet rack.

The load from the horizontally disposed shelves on the gondola or pallet rack is supported by a plurality of vertical supports. To support the load communicated to the vertical supports from the shelving and products thereon, each vertical support extends from one of the horizontal supports and extends substantially perpendicular to the underlying support surface.

Horizontal shelves located on such a gondola, or display rack or pallet rack, conventionally have horizontally disposed support struts, each of which is engaged with at least two of the vertical support members extending from the support upon a horizontal support member. These shelves extend horizontally away from the centrally located vertical supports to respective distal ends. The shelves are usually adjustable to differing elevational positions of engagement upon the vertical support members above the horizontal support members. The shelves can thus be positioned in a tiered arrangement to accommodate merchandise of differing heights between spaced shelves.

The lowest shelf of such gondolas, display racks and pallet racks, is conventionally elevated above the support surface or floor. This elevated position is a distance above the floor determined by the width of the underlying horizontal support members, or base brackets, plus the length of protrusion of adjustable feet or base shoes extending between a bottom surface of the horizontal support members, and the underlying floor.

These feet are adjustable for length and a plurality of such feet extend from each aligned pair of horizontal support members, which are also known as base brackets or base shoes. The feet so engaged hold these horizontal support members spaced from the underlying floor or support surface. This spacing may be adjusted by adjusting the length the feet project from the underside fo the horizontal support members to thereby level the shelves of the gondola or pallet rack or other display or storage rack.

Because floors or support surfaces tend to have divots and recesses and uneven areas which form over time, the employment of these adjustable feet has become a standard manner with which to elevate the horizontal support members underlying lowest shelf above the floor. Adjustment of the length of protrusion of the feet also allows for leveling of the shelves of the gondola or pallet rack, by adjusting the length of the projection of these feet to accommodate uneven floor surfaces.

The system herein employs a lifting member which is adapted to easily engage and form a cradle with these horizontal support members which extend from opposite sides of each upright or vertical support member supporting the engaged shelves. The lifting member features a pair of connecting members which are configured to engage with each other and form a cradle in a sandwiched engagement around the horizontal support members of the gondola, display rack or similar shelving. Each lifting member in this sandwiched engagement with each horizontal support member, is also configured to achieve a registered positioning relative to the feet projecting from the underside of each horizontal support member.

Each connecting member is configured to removably engage with the other of the two connecting members using projecting members or tongues extending therefrom. These tongues or projections are in registered positions configured to engage with mating openings formed upon the other of the two connecting members being paired. Preferably each connecting member is formed identical to the others and in a manner where any two connecting members chosen to form a lifting member will form this engagement between the projections or tongues on one connecting member with the openings positioned on the other.

Additionally, where feet project from the horizontal support members of a gondola or pallet rack, the projections or tongues may be positioned such that a slot is formed and positioned between pairs of projecting tongues. When the tongues of two paired connecting members are mated to form a lifting member sandwiched around the horizontal support member, their engagement with respective openings is positioned to form a slot which surrounds each one or more of the feet projecting from the underside of the horizontal support member. This registered positioning of the slots between projecting tongues to surround projecting feet is a preferred mode in that it registers each formed lifting member in a similarly situated position as others engaged to lift the gondola or pallet rack, making the lift more balanced and secure. It also gives workers a means to determine the connecting members are properly positioned to form the lifting member on the gondola or pallet rack which is important.

Each connecting member in each pair forming a lifting member, has end portions which may be telescopically engaged with one side of a central portion of each connecting member. This engagement while not crucial is preferred as it provides utility in that a translation of the end portions upon the central portion provides a means for adjustment of the length of each connecting member. Further, such a translation of the end portions upon the central portion of each such connecting member, provides a means for length adjustment to position the gap between the engaged tongues adjacent the distal end of each end portion, in a registered position with a foot projecting therethrough, and thereby adjust for the differing spacing of projecting feet from differing gondolas or pallet racks.

The central portion of each connecting member is preferably configured with projecting engaged tongue portions located in registered positions adapted to engage respective openings positioned on the other central portion of a mating connecting member forming a lifting member. The projecting tongue portions of the two central portions when engaged with respective openings, are preferably positioned in-between two centrally located feet projecting from the horizontal supports.

Engagement of the respective tongue portion of one connecting member in each pair with the other in forming a lifting member, holds the two connecting members in each lifting member, in registered positions while in a sandwiched engagement surrounding a horizontal support member of the gondola and frictionally engaged therewith. Upon an elevating of the formed connecting member by an engaged wheeled lifting component such as a dolly with a jack, the horizontal support member is raised by contact with the tongues running underneath the horizontal support member, and provides support for the weight of the gondola or pallet rack communicated to each elevated horizontal support.

The endpiece of each connecting member of a pair forming a lifting member, is configured for positioning within a yoke engaged with wheeled lifting component such as a dolly having a jack operatively positioned thereon. A translating lock on a faceplate positioned upon the dolly is positionable to engage a recess in each of the endpieces of each connecting member forming a lifting member, to lock it in engagement with a yoke.

Each faceplate of each dolly is operatively engaged with a jack positioned upon the dolly such that operation of the jack will cause a translation of the faceplate toward or away from the underlying support surface. Translation of the faceplate away from the support surface in turn elevates the lifting member engaged with the yoke, which in turn elevates the horizontal support members engaged with the lifting member resulting in elevation of the gondola or pallet rack above the support surface.

In this fashion, using a plurality of lifting members, each operatively engaged with one of the horizontal support members of a gondola, and a plurality of operatively engaged dollies, the entire gondola is elevated and supported by the wheeled dollies once the jacks on each dolly are operated to translate and raise the faceplate and yoke engaged with one end of each lifting member.

In a particularly preferred mode of the system, allowing for gondolas and pallet racks to be pre configured for lifting, the connecting members can be engaged to form connected lifting members on each of multiple gondolas or pallet racks. Subsequently, the dollies may be engaged and removed from their engagement with the lifting members, and the lifting members left engaged with the gondola if desired, when the gondola is lowered to the ground or support surface. The dollies thus may be engaged to another set of lifting members on another gondola, and also may be easily re-engaged to the ends of the lifting members they were removed. This is preferable because it allows the system herein to operate more effectively allowing for pre configuring of gondolas and pallet racks with lifting members for subsequent lifting and moving. Such helps minimize worker time and resulting costs.

It is thus an object of this invention to provide an easily engageable lifting system for gondolas and display racks.

It is a further object of this invention to provide such a gondola lifting system which includes lifting members which are easily and securely engageable to a gondola and are also removably engageable with dollies having lifting ability as needed.

It is yet another object of this invention to provide interchangeable yokes and lifting members which are universally adaptable to engage and lift pallet racks and gondolas having any horizontal support member configuration.

These together with other objects and advantages which become subsequently apparent reside in the details of the construction and operation as more fully hereinafter described and claimed, reference being had to the accompanying drawings forming a part thereof, wherein like numerals refer to like parts throughout.

With respect to the above summary, before explaining at least one preferred embodiment of the herein disclosed gondola lifting and mobilization invention in detail, it is to be understood that the invention is not limited in its application to the details of construction and to the arrangement of the components in the following description or illustrated in the drawings. The invention herein described is capable of other embodiments and of being practiced and carried out in various ways which will be obvious to those skilled in the art. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present disclosed device. It is important, therefore, that the claims be regarded as including such equivalent construction and methodology insofar as they do not depart from the spirit and scope of the present invention.

### BRIEF DESCRIPTION OF DRAWING FIGURES

FIG. 1 depicts a perspective view of a conventional gondola or display rack and showing lifting members herein formed of mated of paired connecting members in sandwiched engagement with three horizontal support members, and with dollies engaged with yokes upon opposing sides of one lifting member.

FIG. 2 depicts a perspective view of a merchandise-loaded gondola such as in FIG. 1, and showing a second view of the lifting members formed of connecting members in a sandwiched engagement with horizontal support members and with dollies engaged to opposite sides of one lifting member.

FIG. 3 depicts a perspective, underside view of a lifting member formed of two connecting members in a sandwiched engagement with a horizontal support member of a gondola, and showing the engagements between projections or tongues and openings on each connecting member engaged adjacent gondola feet forming a cradled engagement for the support member of the gondola.

FIG. 4 depicts a perspective view of one connecting member of a pair forming a lifting member and showing the tongues and openings formed in positions to accept engagement from the second in the pair forming the lifting member to form a cradle for the horizontal support of the gondola or pallet rack.

FIG. 5 depicts a perspective view of the second of a pair of connecting members which forms a lifting member when engaged by respective tongues with respective openings.

FIG. 6 depicts a lifting member formed of the two connecting members showing the tongues of each engaging respective openings of the other and showing the telescopic engagement of end portions to a center portion of each connecting member.

FIG. 7 depicts a perspective view a lifting member of FIG. 6 operatively engaged with a horizontal support member of a gondola with the feet registered in position between tongues of the end portions and on opposing sides thereof in the center portion.

FIG. 8 depicts a lifting member such as in FIG. 7 operatively engaged with a horizontal support member of a gondola, and having dollies operatively engaged on opposite ends thereof.

FIG. 9 depicts the engagement of endpieces of each connecting member forming a lifting member, inserted within a yoke and showing a translating lock in a locked position.

FIG. 10 depicts the endpieces of the two connecting members forming a lifting member in locked engagement with the dolly, and having the yoke which is normally present, removed from the depiction for clarity.

FIG. 10a shows the locking members translated to an engagement in recesses formed into the endpieces of each of the pair of connecting members forming a lifting member.

FIG. 11 shows a jack such as a screw jack positioned upon the wheeled dolly and operatively engaged to translate a faceplate having a latch engaging a yoke wherein translating the faceplate away from the support surface will lift the yoke and the engaged lifting member and gondola.

FIG. 12 depicts a connecting member used to form the lifting members herein, showing the central portion having elongated sections extending axially into an axial cavity of the end portions of the connecting member for a translating engagement.

FIG. 13 shows the connecting member of FIG. 12 having been elongated by a sliding of the two end portions in opposite directions, showing the length adjustment of each connecting member.

FIG. 14 depicts the yoke which provides the interface between the dolly with onboard jack, and the ends of the engaged lifting members formed of paired connecting members.

FIG. 15 is a rear view of the yoke of FIG. 13 showing the overhang and opening configured to engage the latch on the dolly for lifting.

FIG. 16 depicts a front view of a dolly preferred for employment with the system having a latch configured to engage an opening in the yoke, which can be translated adjacent to the support surface.

FIG. 17 depicts a mode of the yoke showing that the endpieces configured to engage the ends of the connecting members forming a lifting member, can either be engaged with the connecting members or may be engaged with the yoke and inserted into the connecting members for use.

### DETAILED DESCRIPTION OF THE PREFERRED EMBODIMENTS OF THE INVENTION

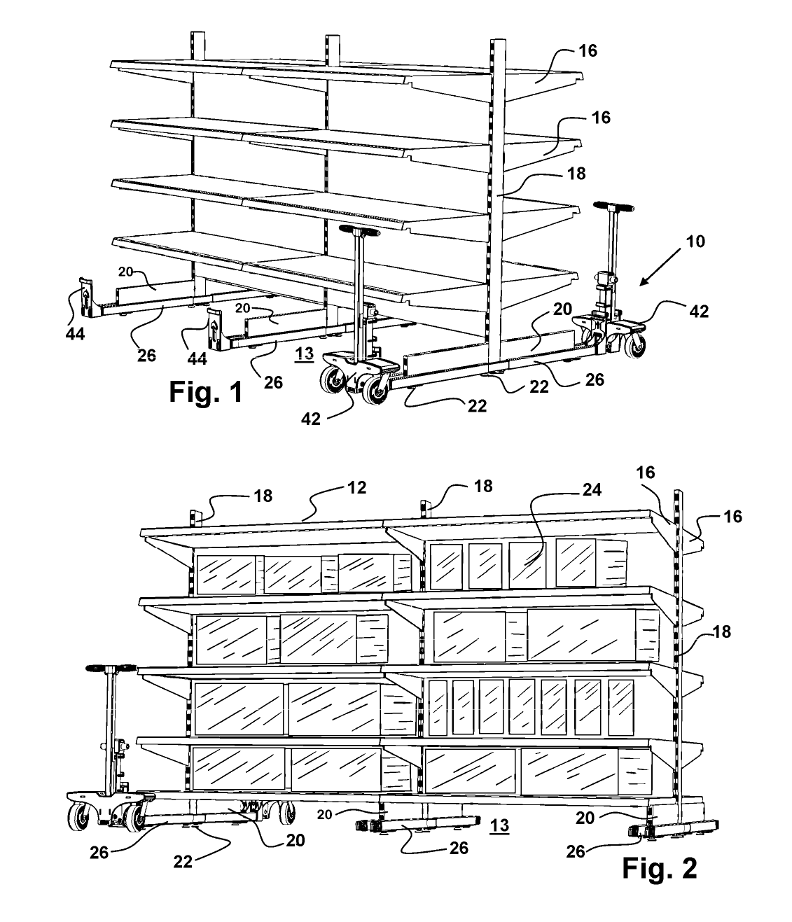

Referring now to the drawings of FIGS. 1-17 there is shown in FIG. 1, a perspective view of the system 10 herein engaged to lift a typical or conventional gondola 12 or a pallet rack employed in stores and warehouses to display or store products.

As noted, conventional gondolas 12 and pallet racks and product display racks, have a plurality of spaced shelves held elevated in spaced configurations using brackets 16 which engage with a plurality of vertical supports 18. Each vertical support 18 conventionally extends substantially perpendicular from a horizontal support 20. The horizontal support 20 is held elevated above the underlying support surface by a plurality of translatably adjustable feet 22 which may be adjusted to level the shelves of the gondola 12. The system 10 as described and shown herein, is configured to engage with and lift the gondola 12 and thereafter move it using engaged wheeled dollies 42.

A similar arrangement to FIG. 1 is shown in FIG. 2 depicts a perspective view of a merchandise 24 loaded gondola 12 such as in FIG. 1. Also shown in FIG. 2, are the lifting members 26, each formed of a pair of connecting members 30 positioned in a sandwiched engagement with each horizontal support member 20. As shown one formed lifting member 26 is depicted with a dolly 28 operatively engaged to both of two ends, and the other lifting members 26 formed of connecting members 30 in a sandwiched engagement with respective horizontal supports 20 are shown ready for such engagement with a dolly 28 and described herein.

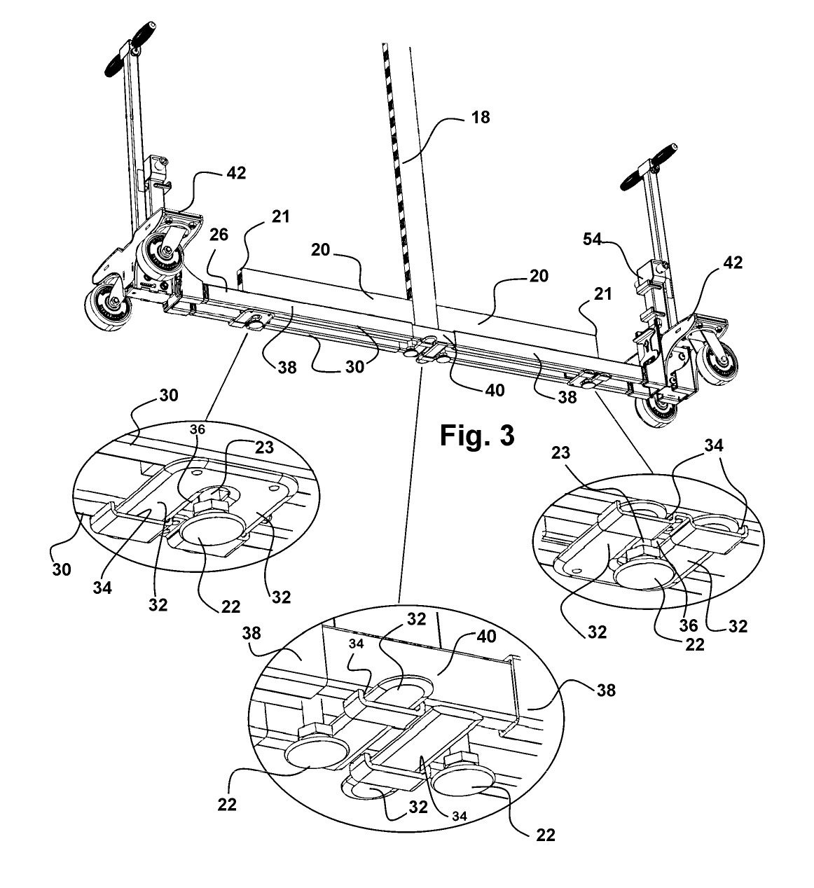

In FIG. 3 there is shown a perspective view depicting an underside view of a lifting member 26 formed of a mating pair of connecting members 30 positioned in a sandwiched engagement on both sides of a horizontal support 20 of the gondola 12 and forming a cradled engagement of the support member 20 of the gondola 12.

Each lifting member 26 is formed of a pair of connecting members 30 which can be removably engaged to each using mating connectors, each of which form a cradled engagement underneath and supporting the horizontal support 20. A plurality of such cradled engagements are formed by the mating connectors which are positioned upon each adjacent connecting members 30. When engaged, the mating connectors which will communicate under the surface of the horizontal support 20 and bear its weight during lifting, and position side surfaces opposing connecting members 30 adjacent sides of the support member 20.

A currently preferred mating connector on each connecting member 30 will form a cradled support to hold the weight of the horizontal support 20 for the gondola 12 during lifting. This formed cradled support is essentially U-shaped and formed by the sidewalls of opposing connecting members 30 and the engaged mating connectors such as the tongue 32 and openings 34.

As shown in FIG. 3, projections or tongues 32 on one connecting member 30, removably engage with openings 34, positioned on the opposing connecting member 30, in the pair of adjacent connecting members 30 forming a lifting member 26. The engagement of the plurality of the mating connectors will thus contact the underside of the horizontal support 20 during lifting. This as noted forms a cradled support with each such connection where the support member 20, is supported by contact of the mating connector with the underside of the lifting member 26 and which is supported on both ends, as well as contact of side surfaces of the opposing connecting members 30 forming the lifting member 26.

The tongues 32 and openings 34 or other mating connector extending under the horizontal support 20 with the two connecting members 30 in sandwiched engagement with the horizontal support 20, forms a plurality of mating connections each of which cradle the support member 20 of the gondola 12, are also sufficient to hold the formed lifting member 26 together and engaged upon and under a respective horizontal support 20. As shown, if the tongues 32 and openings 34 are positioned to surround projecting feet, the engagement of the mating connectors also forms a block or barrier preventing lateral translation of the two connecting members 30 during engagement and support of the horizontal support member 20.

Such an engagement is depicted in the enlarged portions of FIG. 3, showing the registered positioning of the mating connectors depicted as engaged tongues 32 with openings 34, at positions adjacent to an distal end 21 of the horizontal support 20, such that the stem 23 of the foot 22 engaged to the horizontal support 20, extends through a formed gap 36. This positioning is as noted, particularly preferred because it places tongues 32 on either side of the foot 22 used to support the weight of the gondola 12. By placing the tongues 32 underneath the horizontal support 20, adjacent to the foot 22 engagement therewith, the weight of the gondola 12 is transmitted from the same area of the horizontal support 20 as the foot 22 and to the tongues 32.

This positioning of the mating connectors formed by the tongue 32 engaged at a first end to a first connecting member 30 and engaged at a distal end by insertion into openings 34, both forms a cradle to support the weight of horizontal support 20 and maintains the weight transfer to the formed lifting member 26 from the same area of the horizontal support 20 as would normally transfer weight to the feet and floor, thereby maintaining communication of the weight through any structural reinforcements or the like which might be provided to transfer weight to a foot 22. As noted, other mating connectors engaged between the opposing connecting members 30 which form a U-shaped cradle with support under and on the sides of the horizontal support 20 may be employed so long as they engage to support the lower surface of the support 20 and maintain the sides of each connecting member 30 adjacent opposite sides of the support member 20.

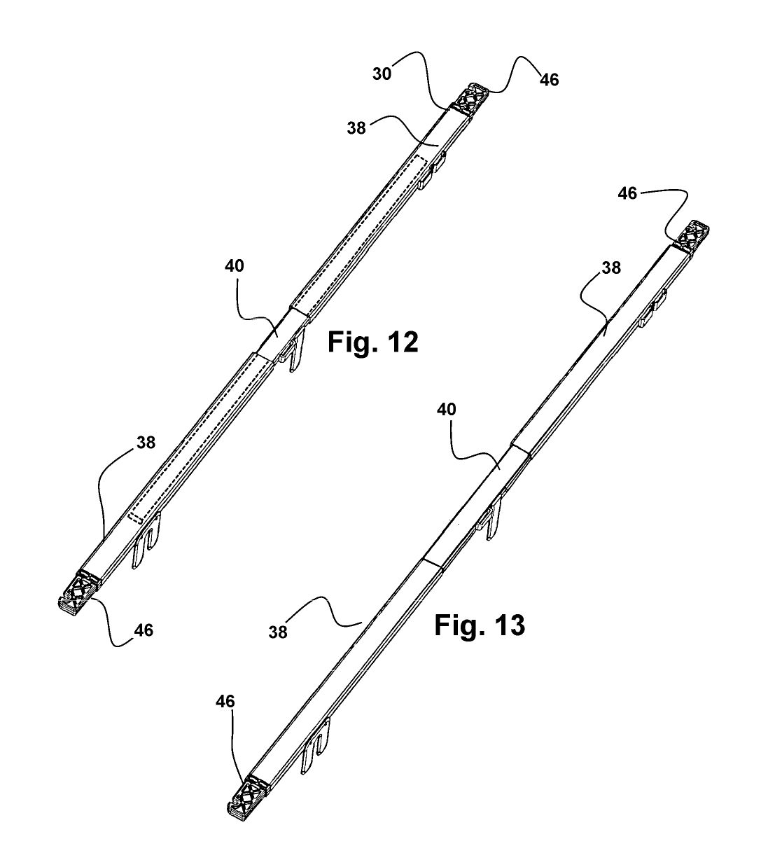

Depending on the manufacturer, the feet 22 adjacent to the distal ends 21 of the horizontal support 20, can vary in position slightly. In a preferred mode of the system 10 herein is accommodated in the formation of the lifting members 26. Each connecting member 30, includes two end portions 38 of each connector member 30 which is in a telescopic translating engagement with a central portion 40 of the formed connecting member 30 (FIGS. 12 and 13). This translating engagement allows the end portions 38 to be translated in their engagement to extensions of the central portion 40, to position the mating connectors shown as tongues 32 and openings 34, to position the foot 22 in a central portion of the gap 36 between the tongues 32 which are engaged in the connections with openings 34 and running between each of the two connecting members 30 forming a lifting member 26. This as noted positions the support provided to the horizontal support 20 by the tongues 32 immediately adjacent to the foot 22 in a position to support the weight on a support surface as designed originally.

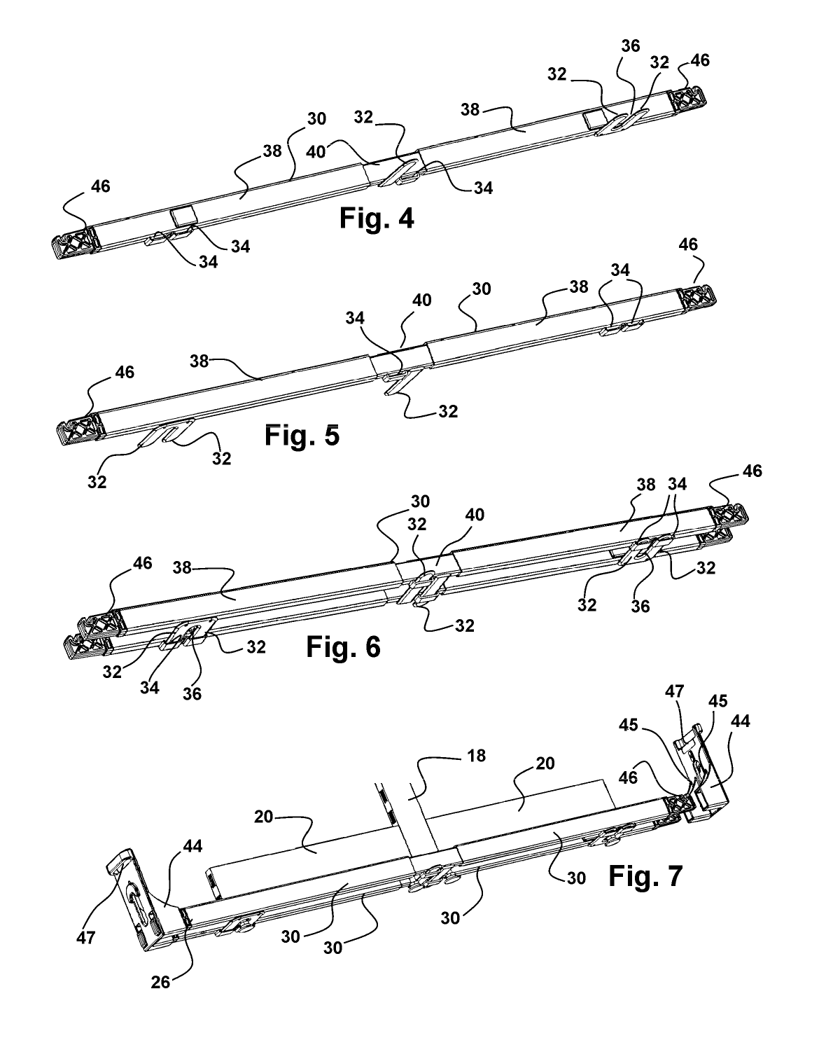

Shown in FIG. 4 is a perspective view of one connecting member 30 which is included in the pair of connecting members 30 which engage to form a lifting member 26 such as in FIG. 6. FIG. 5 shows the mating connector member 30 in the pair forming the lifting member 26 of FIGS. 6 and 7.

Depicted in FIGS. 4-6, the mating connectors are tongues 32 and openings 34 formed upon both of the connecting members 30, in positions to engage the mating tongue 32 with an opening 34 on the other of the pair of connecting members 30 forming a lifting member 26.

As can also be seen in FIGS. 4-7, each connecting member 30 is formed of two end portions 38 which are translatably engaged in an axial passage at one end, with the central portion 40 of the formed connecting member 30. This translating engagement as noted allows the user to slide the two end portions toward and away from each other to change the length of the formed lifting member, and to align the gap 36 between tongues 32, with the stem 23 of the foot 22. In this position, when the lifting member 26 is lifted by the engaged dollies 42, the tongues 32 contact and lift the underside of the horizontal support 20 immediately adjacent to the stem 23, and thereby lift the gondola 12 with the weight thereof communicated to the same area as the feet 22 insuring the structure performs as designed to carry the weight of the gondola 12.

In FIG. 7, a perspective view a lifting member 26 formed of two connecting members 30 shown in FIGS. 4-5, is depicted in an operative sandwiched engagement with a horizontal support 20 of a gondola 12. Each of the horizontal supports 20 of a gondola 12 or pallet rack or display structure, will be so engaged with a lifting member 26. Also shown in FIG. 7, is a yoke 44 which has slots 45 for positioning the endpieces 46 of each lifting member 26 therein as noted herein below.

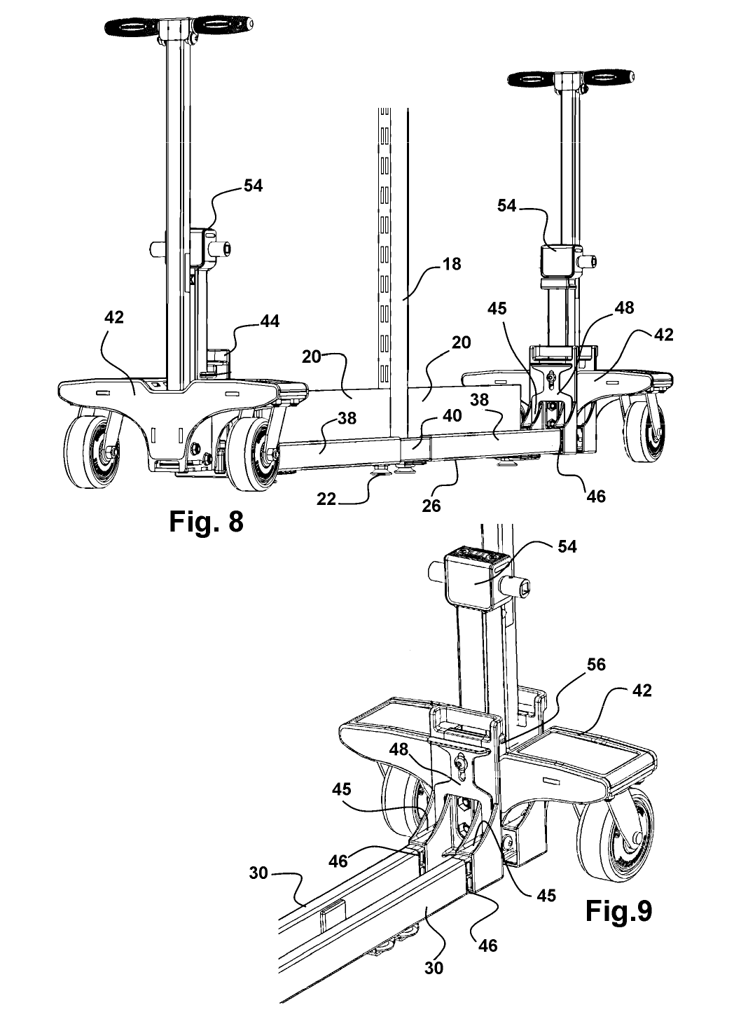

FIG. 8 depicts a gondola 12 pallet rack, or similar structure, in an elevated position above a support surface 13. As shown in FIG. 8 the lifting member 26, such as in FIG. 7, once operatively engaged with a horizontal support member 20, of a gondola 12, can then be engaged to a pair of wheeled dollies 42 by engagement of the endpieces 46 of each connecting member 30 forming the lifting member 26 within the slot 45 of the yoke 44. The yoke 44 may be attached to the wheeled dolly 42 before engagement to a lifting member 26, or it may be attached to a wheeled dolly 42 after it has been operatively engaged to the endpieces 46 of a lifting member 26.

Once the endpieces 46 of the lifting member 26 are engaged with the yoke 44, a sliding lock 48 as shown in FIG. 9, may be engaged to lock the endpieces 46 within their engagement in the slots 45 of the yoke 44. By locking the endpieces 46 to the yoke 44, the wheeled dolly 42 attached to the yoke 44 is maintained in engagement with the lifting member 26 during elevation and moving of a gondola 12. Until the lock 48 is translated to release the locked engagement with the endpieces 46 of the lifting member 26, the yoke 44 and connected wheeled dolly 42 will remain in fixed engagement to the endpieces 46 of each lifting member 26.

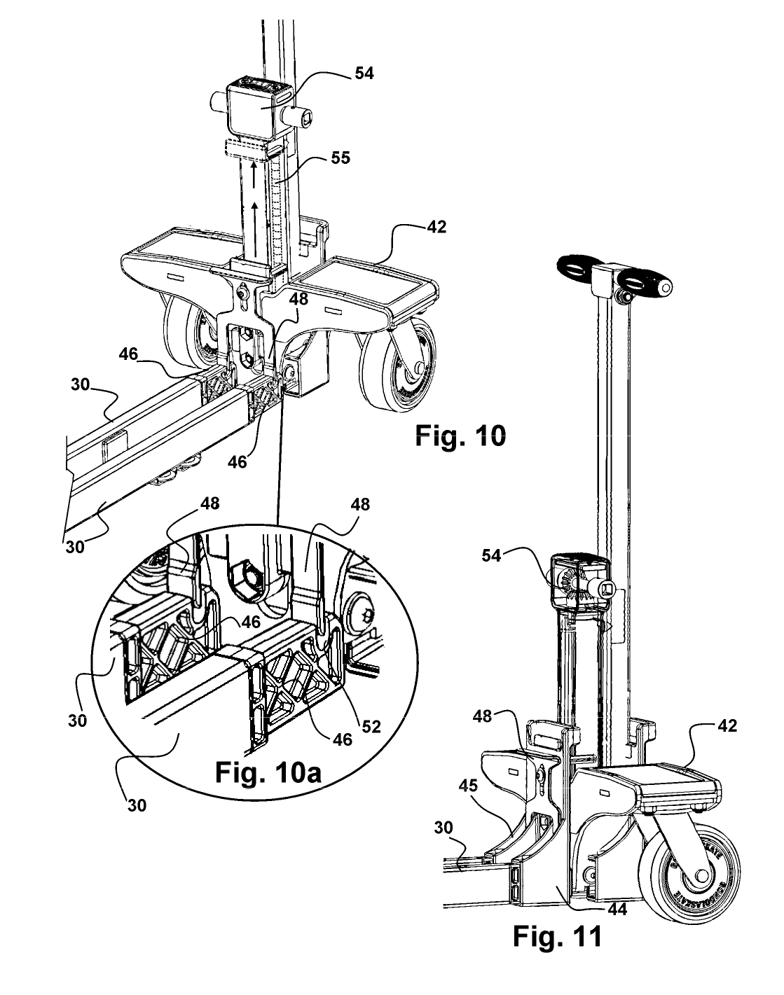

FIGS. 10 and 10a show the engagement of the endpieces 46 of each of the connecting members 30 forming the lifting member 26, in the locked engagement with the lock 48, but with the yoke 44 removed from the illustration for clarity. As can be seen in the enlarged segment of FIG. 10a, the lock 48 when translated toward the support surface 13, engages locking members 50 within recesses 52 formed into the endpieces 46 of each formed lifting member 26.

Once in this locked engagement as noted, the yoke 44 will remain in operative engagement with the endpieces 46 which engage between the yoke 44 and the lifting member 26 until the lock 48 is released. Other locks may be employed as would occur to those skilled in the art, but the depicted lock 48 into the slots 52 as shown herein works particularly well and allows the endpieces 46 engaged with the lifting members 26, to be disengaged from the yoke 44, or maintained in engagement with the yoke 44, where the endpieces are removable from the connecting members 30. Further, using the lock 48 engaged with the endpieces 46 which are engaged with the connecting members 30, the yoke 44 can be disengaged from the latch on the dolly 42 and left in place for later re engagement.

Elevation of the lifting member 26 operatively engaged with a yoke 44 is accomplished by a jack 54 positioned upon the wheeled dolly 42. As shown in FIG. 10, the jack 54 may be a screw jack which with geared engagement between a drive 58 and a rotating screw 55 running axially through the housing and engaged with a latch 49 attached to a faceplate 56 (FIGS. 13-15) which is engaged upon the screw 55 operated by the drive 58.

In this configuration, rotation of the drive 58 will rotate the screw 55 and cause the latch 49 to rise. With the yoke 44 engaged with the latch 49 inserted under the overhang 51 of the opening 47 (FIGS. 13-15), the yoke 44 will rise above the support surface 13 and elevate the lifting member 26 which is engaged to the horizontal support 20 of the gondola 12.

Using opposing jacks on wheeled dollies 42 on both sides of the lifting member 26 in this fashion, will cause the elevation of the gondola 12 above the support surface supported by the formed cradled supports. The gondola 12 may be held in the elevated position and may be rolled upon the wheels 59 of the dolly 42. The jack 54 may also be hydraulic or translated by other means of mechanical advantage however the screw jack shown works well and is simple to operate and maintain and is preferable.

As this operation elevates the engaged lifting members 26 while in cradled contact with the support members 20 and lifts the gondola 12 out of contact by its feet 22 with the support surface 13, it will remain supported in an elevated position by the wheeled dollies 42 until the jack is rotated in reverse to translate the latch 49 and engaged yoke 44 downward. So elevated, the gondola 12 may be rolled upon the wheels 59 of the dollies 42 to a new position. Of course it should be noted that jacks 54 other than the depicted screw jack can be employed so long as the jack 54 is engaged to the wheeled dolly 42 in a manner to allow it to engage and lift the yoke 44 while the yoke is operatively engaged to the lifting member 26.

FIG. 12 depicts a connecting member 30 used to form the lifting members 26 herein, showing the central portion 40 having elongated sections extending axially into an axial cavity of the end portions 38 of the connecting member 30 for a translating engagement. As noted this allows for length adjustment of the connecting member 30 and formed lifting member 26 to accommodate differing configurations of gondolas 12.

FIG. 13 shows the connecting member 30 of FIG. 12 having been elongated by a sliding of the two end portions 38 in opposite directions, showing the length adjustment of each connecting member 30.

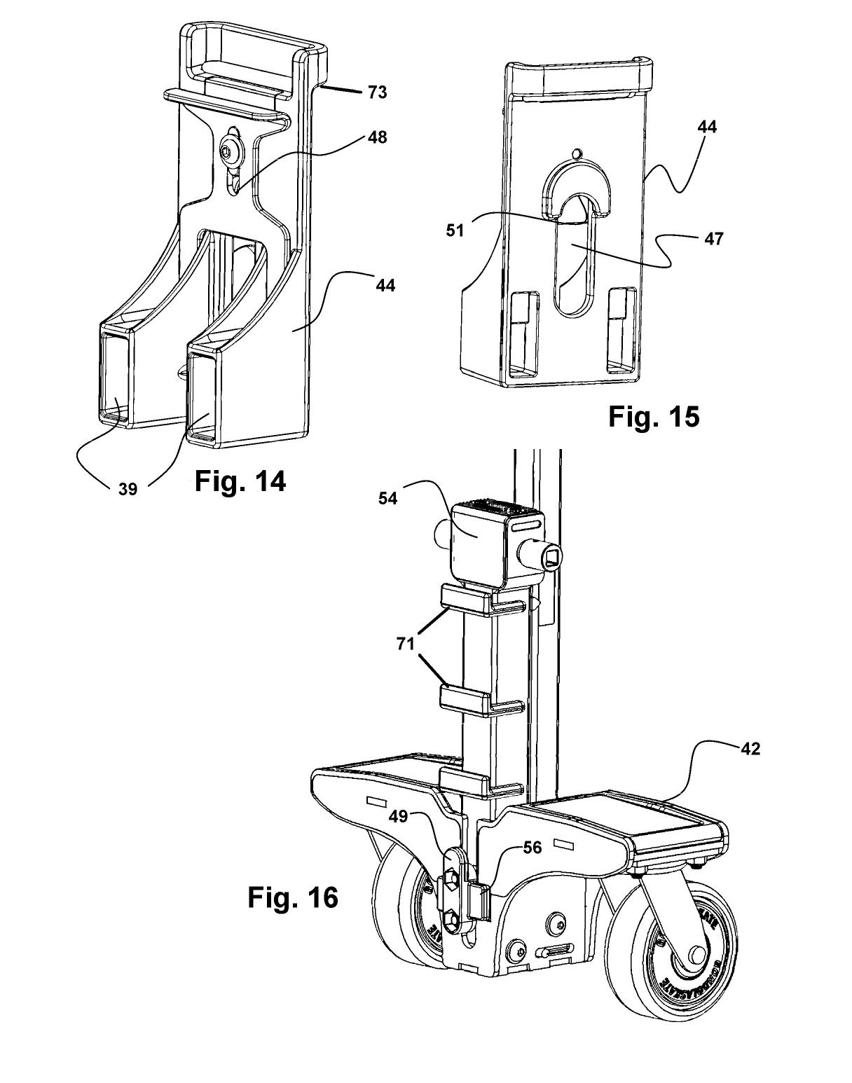

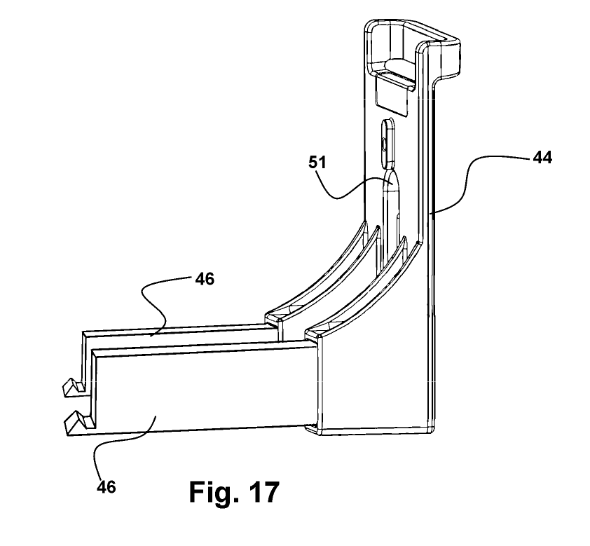

FIG. 14 is a depiction of the yoke 44 which provides the lifting interface between the wheeled dolly 42 having an onboard jack 54 such as in FIG. 16, endpieces 46 which engage within the interior of both connecting members 20 which form the lifting member 26. As noted herein, the endpieces 46 can be engaged and extend from the ends of each connecting member 30, or they can be engaged to extend from openings 39 in the yoke 44 such as in FIG. 17. In some cases where smaller gondolas 12 of display cases are being lifted, it may be beneficial to have the endpieces 46 extend from the yoke 44 and be slid into engagement with the connecting members 30 once they are engaged to the gondola 12 to form a cradled lifting member 26.

FIG. 15 is a rear view of the yoke 44 of FIG. 13 and other figures herein, showing the opening 47 having an overhang 51 which is configured engage upon the latch 49 (FIG. 16) which is operatively engaged for translation using the jack 54 on the dolly 28. This engagement is maintained by gravity acting on the yoke 44 and the weight of the gondola 12 once raised.

In FIG. 16 is shown a front view of a preferred dolly 42 with wheels, for employment with the system 10 herein. The dolly 42 as shown as an onboard jack 54 which operates as noted to translate a having screw-engaged faceplate 56 engaged to the latch 49. A latched engagement between the yoke 44 and the faceplate is formed by a latch 49 that projects upward and is shaped to engage the overhang 51 of the opening 48 in the yoke 44. This configuration of the dolly 42 with the latch 49 which descends to a point within an inch or less of the support surface 13, allows for easy engagement of the endpieces 46 with the yoke 44 or the yoke 44 with endpieces 46 to the open ends of each connecting member 30, with the gondola 12 situated on the support surface 13. Of course other latched engagements of the yoke 44 with the faceplate 56 of the jack can be employed so long as they are preferably removably engageable to allow the yoke 44 to disconnect and remain engaged with the endpieces 46.

Also shown in FIG. 16 are ledges 71 positioned on the dolly 42 which are configured to engage ledge openings 73 (FIG. 14) on the yoke 44. This allows the yoke 44 to be hung from the ledges 71 on the dolly 42 when not in use and is particularly preferred since it helps maintain the yoke 44 proximate to the dolly 42 for operative engagement with the lifting member 26 when needed.

Shown in FIG. 17 is a mode of the yoke 44 showing that the endpieces 46 configured to engage the recess in both ends of the connecting members 30 forming a lifting member 26, can either be engaged with the connecting members 30 as in FIGS. 4-7, or may be engaged to project from the yoke 44 and then inserted into the connecting members 30 while engaged to the yoke 44. As shown the endpieces 46 in FIG. 17 would both insert into the open ends of connecting members 30 forming a lifting member 26, and the notches would engage a spring loaded latch or some other means to removably lock the endpieces 46 into the open ends of the connecting members 30.

While all of the fundamental characteristics and features of the invention have been shown and described herein, with reference to particular embodiments thereof, a latitude of modification, various changes and substitutions are intended in the foregoing disclosure and it will be apparent that in some instances, some features of the invention may be employed without a corresponding use of other features without departing from the scope of the invention as set forth. It should also be understood that various substitutions, modifications, and variations may be made by those skilled in the art without departing from the spirit or scope of the invention. Consequently, all such modifications and variations and substitutions are considered included within the scope of the invention as defined by the following claims.

What is claimed is:

1. A lifting system for a gondola having shelves extending from vertical members supported by horizontal support members which are positioned upon a support surface, comprising:
a lifting member, said lifting member extending between a first end and second end, said lifting member configured to form a cradled support for said horizontal support member;
each of said first end and said second end in an engagement with a yoke;
each yoke in said engagement with said first end and said second end of said lifting member, configured to engage with a jack positioned upon a wheeled dolly; and
whereby with said lifting member forming said cradled support of said horizontal support member, and each said yoke engaged with a respective said jack, said gondola can be elevated above said support surface by operation of said jacks to translate said yokes in a direction away from said support surface.

2. The lifting system for a gondola of claim 1, additionally comprising:
said lifting member is comprised of a first connecting member positionable on a first side of said horizontal support member and a second connecting member positionable on a second side of said horizontal support member;
mating connectors engaged between said first connecting member and said second connecting member, said mating connectors extending below a lower surface of said horizontal support member facing said support surface; and
said cradled support formed by a first surface of said first connecting member adjacent said first side of said horizontal support member and a first surface of said second connecting member adjacent said second side of said horizontal support member and said mating connectors engaged between said first connecting member and said second connecting member.

3. The lifting system for a gondola of claim 2, wherein said mating connectors are formed by a projection extending from a first end engaged with one of said first connecting member or said second connecting member, to a distal end in an engagement with an opening positioned on the other of said first connecting member and said second connecting member; and
said distal end of said projection in said engagement with said opening preventing lateral translation of said first connecting member relative to said second connecting member.

4. The lifting system for a gondola of claim 3 additionally comprising:
a plurality of said mating connectors engaged between said first connecting member and said second connecting member;
gaps formed in-between adjacent said mating connectors of said plurality of mating connecters; and
said gaps adapted to form a surrounding engagement of a stem extending between said horizontal support member and a foot in contact with said support surface.

5. The lifting system for a gondola of claim 2 additionally comprising:
said engagement of each of said first end and said second end of said lifting member with said yoke is a removable engagement between endpieces extending from both ends of said first connecting member and both ends of said second connecting member;
a lock positioned upon each said yoke;
said lock positionable to an engagement with each of said endpieces in a locked connection to said yoke preventing disengagement of said endpieces from said yoke; and
said lock positionable to a disengaged position disconnected from said endpieces whereupon said yoke is removable from said lifting member.

6. The lifting system for a gondola of claim 3 additionally comprising:
said engagement of each of said first end and said second end of said lifting member with said yoke is a removable engagement between endpieces extending from both ends of said first connecting member and both ends of said second connecting member;
a lock positioned upon each said yoke;
said lock positionable to an engagement with each of said endpieces in a locked connection to said yoke preventing disengagement of said endpieces from said yoke; and
said lock positionable to a disengaged position disconnected from said endpieces whereupon said yoke is removable from said lifting member.

7. The lifting system for a gondola of claim 4 additionally comprising:
said engagement of each of said first end and said second end of said lifting member with said yoke is a removable engagement between endpieces extending from both ends of said first connecting member and both ends of said second connecting member;
a lock positioned upon each said yoke;
said lock positionable to an engagement with each of said endpieces in a locked connection to said yoke preventing disengagement of said endpieces from said yoke; and
said lock positionable to a disengaged position disconnected from said endpieces whereupon said yoke is removable from said lifting member.

8. The lifting system for a gondola of claim 1 additionally comprising:
said engagement of each of said first end and said second end of said lifting member with said yoke is a removable engagement of endpieces extending from both said first end of said lifting member and said second end of said lifting member and a respective said yoke.

9. The lifting system for a gondola of claim 1 additionally comprising:
said engagement of each of said first end and said second end of said lifting member with said yoke is a removable engagement between endpieces extending from an engagement of a first end with said yoke; and
a second end of said endpieces respectively removably engageable with said first end of said lifting member and said second end of said lifting member.

10. The lifting system for a gondola of claim 2 additionally comprising:
said engagement of each of said first end and said second end of said lifting member with said yoke is a removable engagement between endpieces extending from an engagement of a first end with said yoke; and
a second end of said endpieces respectively removably engageable with said first end of said lifting member and said second end of said lifting member.

11. The lifting system for a gondola of claim 3 additionally comprising:
said engagement of each of said first end and said second end of said lifting member with said yoke is a removable engagement between endpieces extending from an engagement of a first end with said yoke; and
a second end of said endpieces respectively removably engageable with said first end of said lifting member and said second end of said lifting member.

12. The lifting system for a gondola of claim 4 additionally comprising:
said engagement of each of said first end and said second end of said lifting member with said yoke is a removable engagement between endpieces extending from an engagement of a first end with said yoke; and
a second end of said endpieces respectively removably engageable with said first end of said lifting member and said second end of said lifting member.

13. The lifting system for a gondola of claim 1 additionally comprising:
said lifting member formed of a central section translatably engaged with each of to end sections; and
said end sections translatable toward and away from said central section, to vary a length of said lifting member.

14. The lifting system for a gondola of claim 2 additionally comprising:
said lifting member formed of a central section translatably engaged with each of to end sections; and
said end sections translatable toward and away from said central section, to vary a length of said lifting member.

15. The lifting system for a gondola of claim 3 additionally comprising:
said lifting member formed of a central section translatably engaged with each of to end sections; and
said end sections translatable toward and away from said central section, to vary a length of said lifting member.

16. The lifting system for a gondola of claim 4 additionally comprising:
said lifting member formed of a central section translatably engaged with each of to end sections; and
said end sections translatable toward and away from said central section, to vary a length of said lifting member.

17. The lifting system for a gondola of claim 5 additionally comprising:
said lifting member formed of a central section translatably engaged with each of to end sections; and
said end sections translatable toward and away from said central section, to vary a length of said lifting member.

18. The lifting system for a gondola of claim 8 additionally comprising:
said lifting member formed of a central section translatably engaged with each of to end sections; and
said end sections translatable toward and away from said central section, to vary a length of said lifting member.

19. The lifting system for a gondola of claim 9 additionally comprising:
said lifting member formed of a central section translatably engaged with each of to end sections; and
said end sections translatable toward and away from said central section, to vary a length of said lifting member.
